(19) United States
(12) Patent Application Publication
(10) Pub. No.: US 2025/0237741 A1
(43) Pub. Date: Jul. 24, 2025

(54) INFORMATION PROCESSING DEVICE, INFORMATION PROCESSING METHOD, AND PROGRAM

(71) Applicant: SONY SEMICONDUCTOR SOLUTIONS CORPORATION, KANAGAWA (JP)

(72) Inventor: HIROSADA MIYAOKA, KANAGAWA (JP)

(21) Appl. No.: 18/698,112

(22) PCT Filed: Sep. 29, 2022
(86) PCT No.: PCT/JP2022/036367

§ 371 Date: Apr. 3, 2024

(30) Foreign Application Priority Data
Oct. 13, 2021 (JP) 2021-168145

(51) Int. Cl. G01S 7/40; G01S 13/931

(52) U.S. Cl. CPC G01S 7/4052; G01S 13/931

(57) ABSTRACT

The present disclosure relates to an information processing device, an information processing method, and a program that achieve highly accurate simulation in accordance with a real running environment using a millimeter-wave radar. A radio wave interference model for a radar device mounted on a vehicle in a simulation environment is stored, the stored radio wave interference model is selected on the basis of a simulation scenario, and output data representing a result of perception of an object with the radar device is generated on the basis of the selected radio wave interference model. The present disclosure is applicable to an automated driving simulator.

### TECHNICAL FIELD

The present disclosure relates to an information processing device, an information processing method, and a program, and more particularly, to an information processing device, an information processing method, and a program suitable for use in a case where simulation of a millimeter-wave radar is performed.

### BACKGROUND ART

In order to evaluate and verify safety and the like of an automated driving system that enables automated driving, not only a running test that is conducted by driving a vehicle in a real environment (hereinafter, referred to as real running test), but also a running test that is virtually conducted on a system that simulates the automated driving system (hereinafter, referred to as virtual running test) has been conducted.

Here, the automated driving system performs processing including, for example, a perception step, a recognition step, a determination step, and an operation step. The perception step is, for example, a step of perceiving surroundings of the vehicle. The recognition step is, for example, a step of recognizing the surroundings of the vehicle in detail. The determination step is, for example, a step of performing various determinations on the basis of the result of recognizing the surroundings of the vehicle. The operation step is, for example, a step of performing automated operation on the vehicle on the basis of the various determinations. Note that the perception step and the recognition step may be combined into one cognition step, for example.

Among such steps, in the perception step, various sensors that sense the surroundings of the vehicle are used, and sensing results of the various sensors are used as information indicating the surroundings of the vehicle.

Here, the sensors used in the perception step include an image sensor, a millimeter-wave radar, light detection and ranging (LiDAR), and the like, and each sensing result is modeled to achieve simulation.

For example, proposed is a technique of modeling and simulating ghosts caused by multiple reflection for the sensing result of the millimeter-wave radar (see Patent Document 1).

### CITATION LIST

### Patent Document

Patent Document 1: Japanese Patent Application Laid-Open No. 2020-143920

### SUMMARY OF THE INVENTION

### Problems to be Solved by the Invention

Meanwhile, for the virtual running test conducted by means of simulation, models corresponding to various environments are required.

In the technique disclosed in Patent Document 1, however, an interference signal from a millimeter-wave radar mounted on another vehicle is not modeled, so that it is not possible to confirm whether or not realistic and adequate simulation is achieved.

The present disclosure has been made in view of such circumstances, and it is therefore an object of the present disclosure to achieve realistic and highly accurate simulation by modeling an interference signal particularly for simulation of a millimeter-wave radar.

### Solutions to Problems

An information processing device and a program according to one aspect of the present disclosure are an information processing device and a program including a storage unit configured to store a radio wave interference model for a radar device mounted on a vehicle in a simulation environment, a selection unit configured to select the radio wave interference model stored in the storage unit on the basis of a simulation scenario, and a radar model configured to generate output data indicating a result of perception of an object with the radar device on the basis of the radio wave interference model selected by the selection unit.

An information processing method according to one aspect of the present disclosure is an information processing method of an information processing device including a storage unit configured to store a radio wave interference model for a radar device mounted on a vehicle in a simulation environment, the information processing method including selecting the radio wave interference model stored in the storage unit on the basis of a simulation scenario, and generating output data representing a result of perception of an object with the radar device on the basis of the radio wave interference model selected.

According to one aspect of the present disclosure, the radio wave interference model for the radar device mounted on the vehicle in the simulation environment is stored, the stored radio wave interference model is selected on the basis of the simulation scenario, and the output data representing the result of perception of an object with the radar device is generated on the basis of the selected radio wave interference model.

### BRIEF DESCRIPTION OF DRAWINGS

FIG. 1 is a diagram illustrating a configuration example of a millimeter-wave radar.

FIG. 2 is a diagram for describing a principle of how the millimeter-wave radar measures a distance to a target object.

FIG. 3 is a diagram illustrating a principle of how the millimeter-wave radar measures a speed of the target object.

FIG. 4 is a diagram illustrating a principle of how the millimeter-wave radar measures a direction of the target object.

FIG. 5 is a diagram for describing a scenario when one's own vehicle follows the preceding vehicle and there is no interference signal.

FIG. 6 is a diagram for describing a transmission signal and a reception signal under the scenario in FIG. 5, and an IF signal generated as a result of mixing the transmission signal and the reception signal.

FIG. 7 is a diagram for describing a scenario when the one's own vehicle follows the preceding vehicle, an oncoming vehicle is further present, and there is an interference signal.

FIG. 8 is a diagram for describing a transmission signal and a reception signal under a scenario in FIG. 7 where the oncoming vehicle causes a millimeter-wave radar different in model from the millimeter-wave radar of the one's own vehicle to emit, as an interference signal, a transmission signal different in chirp modulation slope.

FIG. 9 is a diagram for describing a transmission signal and a reception signal under a scenario in FIG. 7 where the oncoming vehicle causes a millimeter-wave radar that is the same in model as the millimeter-wave radar of the one's own vehicle to emit, as an interference signal, a transmission signal that is the same in chirp modulation slope.

FIG. 10 is a diagram for describing a transmission signal and a reception signal under a scenario in FIG. 7 where the oncoming vehicle includes a millimeter-wave radar of a model that emits, as an interference signal, a transmission signal different in modulation method from the transmission signal of the one's own vehicle.

FIG. 11 is a diagram for describing a scenario when the one's own vehicle follows the preceding vehicle in a tunnel, an oncoming vehicle is further present, and there is an interference signal.

FIG. 12 is a diagram for describing a transmission signal and a reception signal under a scenario in FIG. 11 where the oncoming vehicle causes a millimeter-wave radar different in model from the millimeter-wave radar of the one's own vehicle to emit, as an interference signal, a transmission signal different in chirp modulation slope.

FIG. 13 is a diagram for describing a transmission signal and a reception signal under a scenario in FIG. 11 where the oncoming vehicle causes a millimeter-wave radar that is the same in model as the millimeter-wave radar of the one's own vehicle to emit, as an interference signal, a transmission signal that is the same in chirp modulation slope.

FIG. 14 is a diagram for describing a transmission signal and a reception signal under a scenario in FIG. 11 where the oncoming vehicle includes a millimeter-wave radar of a model that emits, as an interference signal, a transmission signal different in modulation method from the transmission signal of the one's own vehicle.

FIG. 15 is a block diagram illustrating a configuration example of an automated driving simulator of the present disclosure.

FIG. 16 is a block diagram illustrating a configuration example of a rendering model illustrated in FIG. 15.

FIG. 17 is a block diagram illustrating a configuration example of a millimeter-wave radar model illustrated in FIG. 15.

FIG. 18 is a flowchart for describing automated driving simulation processing.

FIG. 19 is a flowchart for describing rendering step processing illustrated in FIG. 18.

FIG. 20 is a flowchart for describing perception step processing illustrated in FIG. 18.

FIG. 21 is a flowchart for describing millimeter-wave radar step processing illustrated in FIG. 20.

FIG. 22 is a block diagram illustrating a configuration example of a general-purpose computer.

### MODE FOR CARRYING OUT THE INVENTION

Hereinafter, a preferred embodiment of the present disclosure will be described in detail with reference to the accompanying drawings. Note that, in the present specification and the drawings, components having substantially the same functional configurations are denoted by the same reference signs, and redundant descriptions are omitted.

Hereinafter, a mode for carrying out the present technology will be described. The description will be given in the following order.
1. Regarding operation principle of millimeter-wave radar
2. Interference signal model and simulation scenario
3. Application example of simulation scenario and interference signal model
4. Preferred embodiment
5. Example of execution by software

### 1. REGARDING OPERATION PRINCIPLE OF MILLIMETER-WAVE RADAR

The present disclosure is intended to achieve realistic and highly accurate simulation by modeling an interference signal by means of simulation of a millimeter-wave radar.

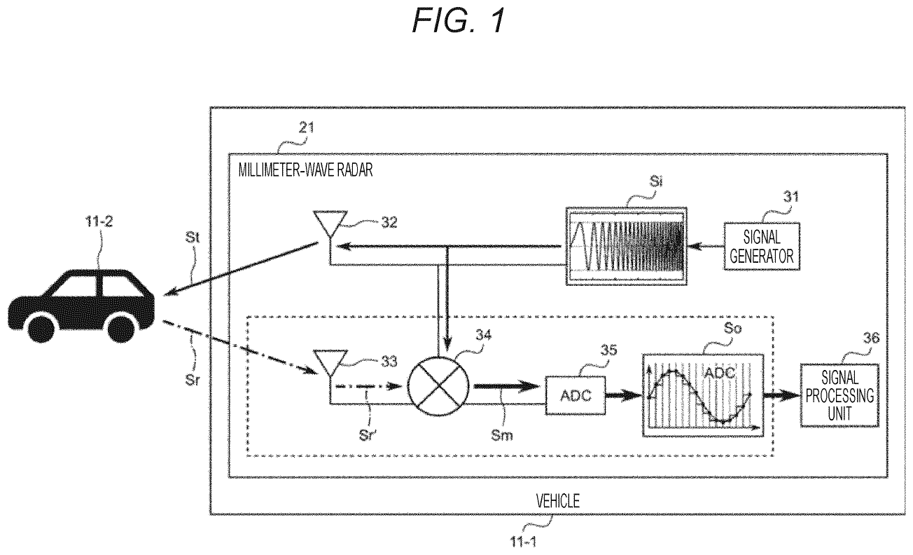

In the description of the present disclosure, an operation principle of a millimeter-wave radar will be described with reference to FIGS. 1 to 4.

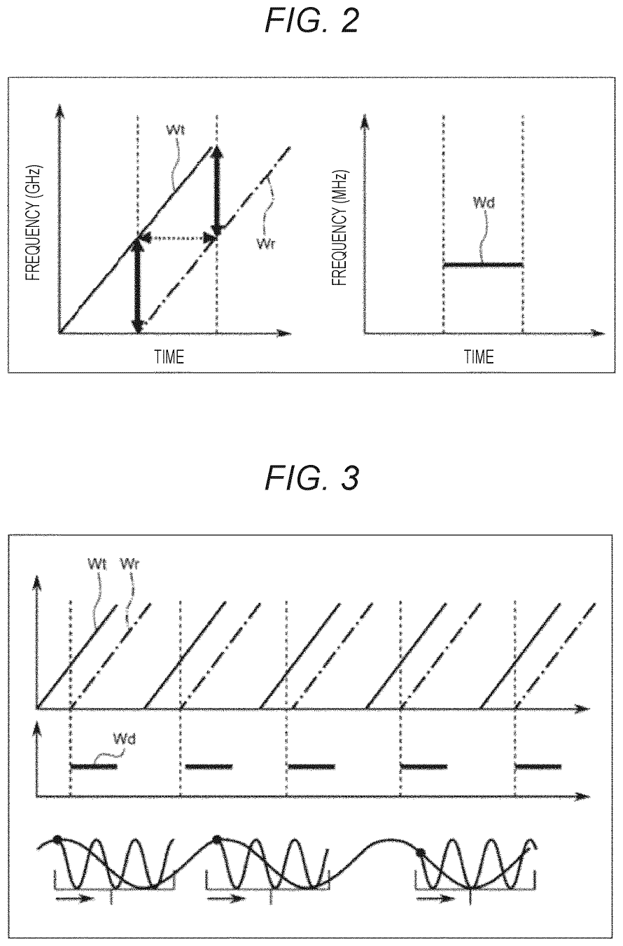

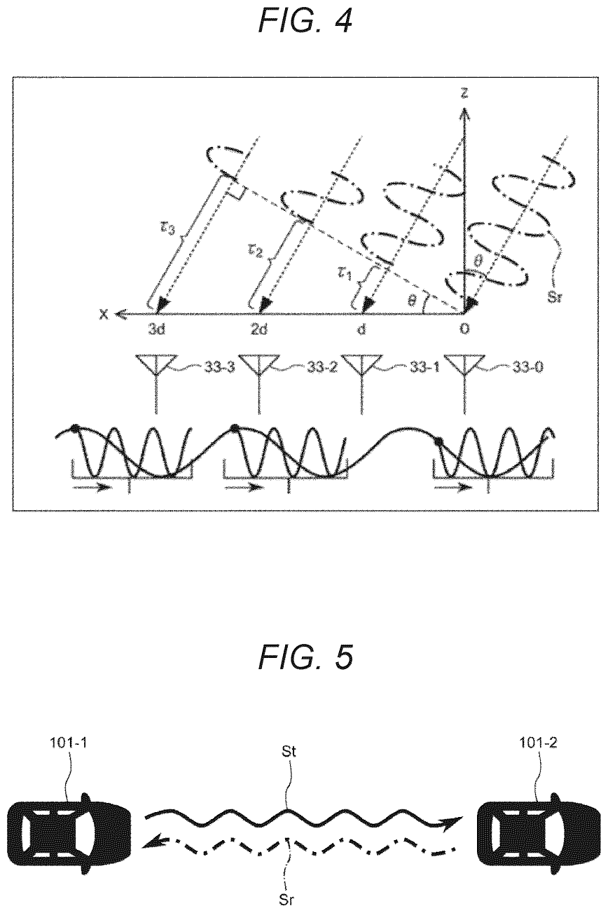

FIG. 1 is a diagram for describing a configuration example of a vehicle equipped with a millimeter-wave radar, FIG. 2 is a diagram for describing a principle of how the millimeter-wave radar measures a distance to a target object, FIG. 3 is a diagram for describing a principle of how the millimeter-wave radar measures a speed of the target object, and FIG. 4 is a diagram for describing a principle of how the millimeter-wave radar measures a direction of an object to be ranged.

Vehicles 11-1 and 11-2 in FIG. 1 enable automated driving on the basis of a detection result of a millimeter-wave radar 21, for example. FIG. 1 illustrates an example where the vehicles 11-1 and 11-2 are running to the left of the drawing. Here, the vehicle 11-1 is represented by only a rectangular frame in the drawing, but is similar in outline to the vehicle 11-2.

Each of the vehicles 11-1 and 11-2 is equipped with the millimeter-wave radar 21. The millimeter-wave radar 21 detects a distance to, a speed of, and a direction of an object present ahead in the running direction and within a predetermined detection range. Note that, in FIG. 1, the millimeter-wave radar 21 mounted on the vehicle 11-1 measures a distance to, a speed of, and a direction of the vehicle 11-2 that is a preceding vehicle to be ranged. The vehicle 11-1 enables automated driving on the basis of, for example, the distance to, the speed of, and the direction of the vehicle 11-2 that is a preceding vehicle present within a detection range, the distance, the speed, and the direction being a measurement result of the millimeter-wave radar 21.

More specifically, the millimeter-wave radar 21 includes a signal generator 31, a transmission antenna 32, a reception antenna 33, a mixer 34, an ADC 35, and a signal processing unit 36.

The signal generator 31 generates a transmission signal Si in the millimeter-wave band to which modulation by which a frequency is changed at a predetermined rate, so-called chirp modulation, is applied, and outputs the transmission signal Si to the transmission antenna 32 and the mixer 34.

The transmission antenna 32 emits, on the basis of the transmission signal Si in the millimeter-wave band supplied from the signal generator 31, a transmission wave St in the millimeter-wave band toward the detection range of an object such as the vehicle 11-2.

At this time, for example, when the vehicle 11-2 to be ranged is present within the detection range, the transmission wave St is reflected off the vehicle 11-2 to generate a reflected wave Sr directed toward the vehicle 11-1.

The reception antenna 33 receives the reflected wave Sr from the vehicle 11-2 to be ranged, and supplies, to the mixer 34, the reflected wave Sr as a reception signal Sr′.

The mixer 34 performs mixing of (mixes) the transmission signal S1 and the reception signal Sr′ to generate a difference signal Sm indicating a difference in frequency between the transmission signal S1 and the reception signal Sr′, and outputs the difference signal Sm to the ADC 35.

The difference signal Sm is a signal corresponding to a difference in frequency between a waveform Wt of the transmission signal S1 and a waveform Wr of the reception signal Sr′ illustrated in the left part of FIG. 2. Note that, in FIG. 2, the horizontal axis represents time, the vertical axis represents frequency, and the waveforms Wt and Wr indicate frequency changes with time of the transmission signal Si and the reception signal Sr′, respectively.

Here, the difference signal Sm indicating the difference in frequency between the waveform Wt of the transmission signal Si and the waveform Wr of the reception signal Sr′ is called an intermediate frequency (IF) signal, and has an IF frequency or a beat frequency that is a frequency difference, and is represented by, for example, a waveform Wd illustrated in FIG. 2. When the distance to the vehicle 11-2 to be ranged is constant, the intermediate frequency (IF) frequency or the beat frequency results in a constant waveform with no change in the time direction as illustrated in the right part of FIG. 2.

The IF signal represented by the waveform Wd having the IF frequency or the beat frequency has a frequency corresponding to a distance twice as long as the distance to the vehicle 11-2 to be ranged, and the frequency decreases as the distance to the vehicle 11-2 decreases; conversely, the frequency increases as the distance to the vehicle 11-2 increases.

The analog digital converter (ADC) 35 converts the IF signal, which is the difference signal Sm that is an analog signal, into an IF signal So, which is a digital signal, and outputs the IF signal So to the signal processing unit 36.

The signal processing unit 36 measures the distance to, the speed of, and the direction of the vehicle 11-2 to be ranged on the basis of the IF frequency or the beat frequency of the IF signal converted into the digital signal.

Note that the reception antenna 33 enclosed in a dotted frame is provided at a plurality of different locations, and the mixer 34 and the ADC 35 are also provided at a plurality of different locations accordingly. Each of the plurality of reception antennas 33 to ADCs 35 generates the IF signal having the IF frequency or the beat frequency that is a difference frequency between the reception signal Sr′ corresponding to the reflected wave Sr received by the reception antenna 33 and the transmission signal Si, converts the IF signal into a digital signal, and outputs the digital signal to the signal processing unit 36.

As described above, the signal processing unit 36 obtains the distance to the vehicle 11-2 to be ranged using the IF signal obtained by one chirp modulation for each of the plurality of reception antennas 33 to ADCs 35.

Furthermore, as illustrated in FIG. 3, in a case where processing of emitting the transmission wave St including the transmission signal Si that is chirp-modulated, and receiving the reflected wave Sr to acquire the reception signal Sr′ and obtaining the IF signal is repeated at high speed, when a relative speed between the vehicle 11-2 to be ranged and the vehicle 11-1 is zero, the IF frequency (beat frequency) of the IF signal does not change, but a phase changes with the relative speed between the vehicle 11-1 and the vehicle 11-2 as illustrated in the lowermost part of FIG. 3.

A speed of the phase change of the IF frequency (beat frequency) corresponds to the speed relative to the vehicle 11-2. Therefore, the signal processing unit 36 measures the speed relative to the vehicle 11-2 in accordance with the speed of phase change at this time.

In this case, the faster the phase change of the IF signal, the higher the speed relative to the vehicle 11-2; conversely, the slower the phase change of the IF signal, the lower the speed relative to the vehicle 11-2.

As described above, the signal processing unit 36 measures the speed relative to the vehicle 11-2 to be ranged on the basis of the phase change of the reflected wave Sr received by repeating the chirp modulation at high speed.

Moreover, as illustrated in FIG. 4, in a case where the reception antenna 33 includes four reception antennas 33-0 to 33-3, and each of the four reception antennas 33-0 to 33-3 is arranged at predetermined intervals d in the horizontal direction (X direction), consider a case where the reflected wave Sr represented by a waveform of a long dashed short dashed line is received at a predetermined incident angle θ.

At this time, the reflected wave Sr received by each of the reception antennas 33-1 to 33-3 has a delay corresponding to distances τ1 to 13 of the incident angle θ relative to the reception antenna 33-0, and has a phase difference corresponding to the delay. Here, the larger the incident angle of the reflected wave Sr from the vehicle 11-2 to be ranged, the larger the phase difference.

As described above, the signal processing unit 36 measures the direction of the vehicle 11-2 to be ranged on the basis of the phase change of each reflected wave Sr received by the plurality of reception antennas 33.

### 2. INTERFERENCE SIGNAL MODEL AND SIMULATION SCENARIO

### (Example of Interference Signal)

Next, an interference signal that is generated during measurement of each of the distance to, the speed of, and the direction of the target object using the millimeter-wave radar will be described.

For example, as illustrated in FIG. 5, a situation is assumed where the vehicles 101-1 and 101-2 are running to the right of the drawing, and at least the vehicle 101-1 is equipped with the millimeter-wave radar.

Here, when the vehicle 101 performs virtual running test, what represents a running environment around the vehicle 101 in a virtual space is referred to as simulation scenario or simply referred to as scenario.

In the scenario represented in FIG. 5, when the millimeter-wave radar mounted on the vehicle 101-1 emits the transmission wave St represented by a solid line in the drawing, which includes the above-described transmission signal Si, toward the front, the transmission wave St is reflected off the vehicle 101-2 that is a preceding vehicle as the reflected wave Sr represented by a long dashed short dashed line.

That is, under the scenario represented in FIG. 5, the millimeter-wave radar of the vehicle 101 receives the reflected wave Sr, obtains the IF signal that is the difference signal Sm on the basis of the reception signal Sr′ based on the received reflected wave Sr and the transmission signal Si, and measures the distance to the vehicle 101-2 that is a preceding vehicle on the basis of the IF frequency (or beat frequency) of the IF signal.

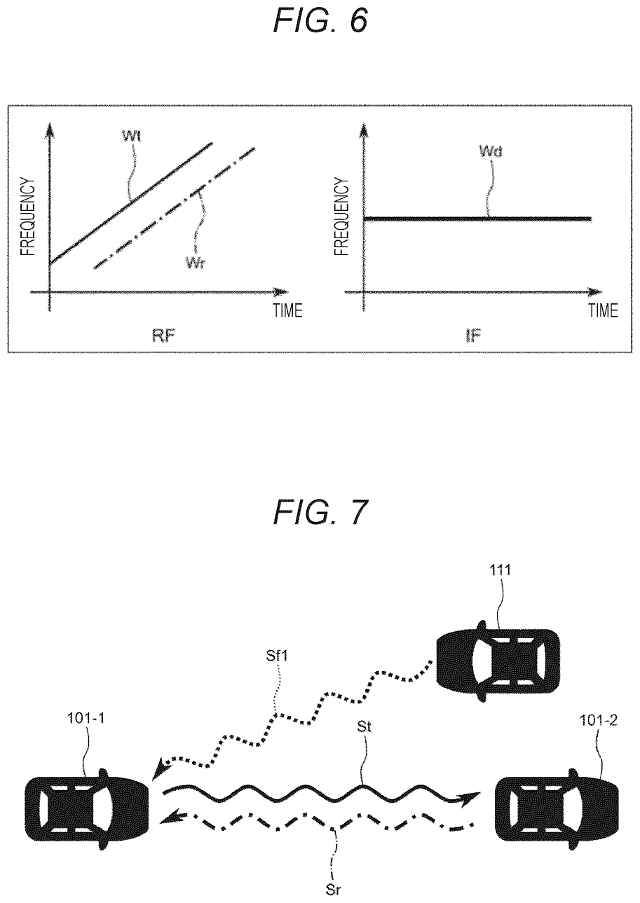

That is, under the scenario in FIG. 5, as described above, the millimeter-wave radar of the vehicle 101-1 acquires the transmission wave St including the transmission signal Si and the reflected wave Sr including the reception signal Sr′ as the waveforms Wt and Wr illustrated in the left part of FIG. 6, respectively. Therefore, the IF frequency (beat frequency) of the IF signal, which is the frequency of the difference signal between the waveforms Wt and Wr, is obtained as the waveform Wd illustrated in the left part of FIG. 6, and the distance to the vehicle 101-2 is measured on the basis of the IF frequency represented by the waveform Wd.

That is, for the scenario in FIG. 5, the waveforms Wt and Wr as illustrated in the left part of FIG. 6 are acquired, so that it is possible for the vehicle 101-1 to appropriately detect the distance to, the speed of, and the direction of the vehicle 101-2 to be ranged.

Note that, for a predetermined scenario, the reception signal Sr′ and the like used for measurement of the distance to the vehicle 101-2 by the vehicle 101-1 serving as a base and represented by the waveform Wr is also referred to hereinafter as signal model set on the basis of the scenario.

That is, for the scenario in FIG. 5, in the vehicle 101-1 serving as a base, the reception signal Sr′ of the waveform Wr used for measurement of the distance to the vehicle 101-2 is set as a signal model, and the distance to the vehicle 101-2 can be measured on the basis of the reception signal Sr′ of the waveform Wr set as the signal model.

In reality, it is, however, conceivable that the vehicle 101-1 runs in various environments, so that there are various possible scenarios.

For example, as illustrated in FIG. 7, a scenario is conceivable where when the vehicle 101-1 runs, a vehicle 111 that is an oncoming vehicle equipped with a different millimeter-wave radar is present.

Under the scenario in FIG. 7, the millimeter-wave radar of the vehicle 101-1 receives not only the reflected wave Sr from the vehicle 101-2, but also a transmission wave Sf1 emitted from the vehicle 111 as an interference signal.

Here, consider a case where a different millimeter-wave radar mounted on the vehicle 111 that is an oncoming vehicle is different in model from the millimeter-wave radar mounted on the vehicle 101-1, and emits the transmission wave Sf1 based on a transmission signal Si different in chirp modulation slope from the transmission signal Si, for example.

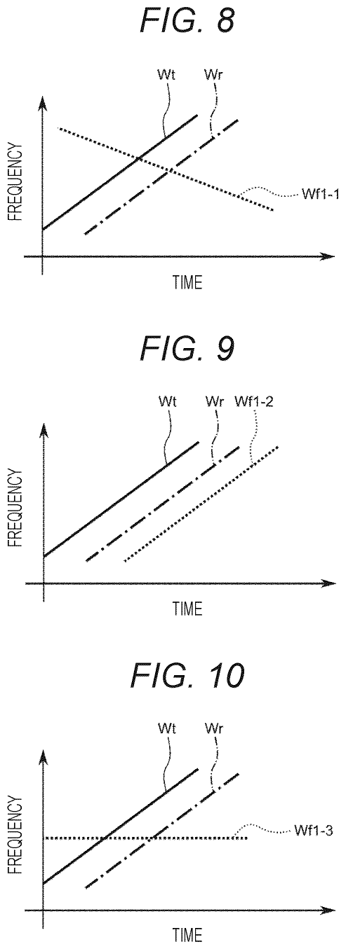

Under this scenario, the millimeter-wave radar of the vehicle 101-1 receives not only the reception signal Sr′ represented by the waveform Wr based on the reflected wave Sr from the vehicle 101-2, but also a signal as represented by a waveform Wf1-1 as illustrated in FIG. 8 as an interference signal, the signal corresponding to the transmission wave Sf1 emitted from the millimeter-wave radar of the vehicle 111, for example.

As described above, in principle, the distance from the vehicle 101-1 to the vehicle 101-2 is measured on the basis of the IF frequency (beat frequency) of the IF signal obtained as a result of mixing the waveform Wt including the transmission signal S1 and the waveform Wr on the basis of the signal model represented by the waveform Wr.

Under the scenario representing the running environment defined by FIGS. 7 and 8 described above, however, the interference signal represented by the waveform Wf1-1 in FIG. 8 is also mixed with the reception signal of the waveform Wr together with the waveform Wt including the transmission signal Si, so that there is a possibility that an error occurs in the IF frequency, and there is a possibility that accuracy of measurement of the distance from the vehicle 101-1 to the vehicle 101-2 deteriorates.

That is, the example in FIG. 8 illustrates an example of a case where the chirp modulation slope of the waveform Wf1-1 representing the transmission signal of the transmission wave Sf1 emitted from the millimeter-wave radar mounted on the vehicle 111 is different from the slope of the waveform Wt representing the transmission signal Si of the transmission wave St emitted from the millimeter-wave radar mounted on the vehicle 101-1.

As illustrated in FIG. 7, a situation where when the vehicle 101-1 runs, the vehicle 111 that is an oncoming vehicle equipped with a different millimeter-wave radar is present, and the different millimeter-wave radar mounted on the vehicle 111 emits the transmission wave Sf1 based on a transmission signal that is different in chirp modulation slope from the transmission signal Si is considered as one scenario.

Under this scenario, a signal model that receives not only the reception signal represented by the waveform Wr but also the interference signal corresponding to the transmission wave Sf1 as represented by the waveform Wf1-1 in FIG. 8 is set.

As described above, among the signal models set for one scenario, a signal model that receives an interference signal is particularly referred to as interference signal model.

As illustrated in FIG. 7, a scenario based on a situation where when the vehicle 101 runs, the vehicle 111 that is an oncoming vehicle equipped with a different millimeter-wave radar is present, and the different millimeter-wave radar emits the transmission wave Sf1 based on a transmission signal different in chirp modulation slope from the transmission signal Si is hereinafter referred to as first scenario.

Furthermore, an interference signal model that is set for the first scenario and includes not only the reception signal represented by waveform Wr but also the interference signal corresponding to the transmission wave Sf1 as represented by the waveform Wf1-1 in FIG. 8 is referred to as first interference signal model.

Note that the example in FIG. 8 illustrates an example where an interference signal different in chirp modulation slope is mixed; however, an interference signal model in which while the waveform Wt is a linearly changing chirp modulation waveform, an interference signal of a non-linear modulation waveform is received or an interference signal model in which an interference signal of a stepwise modulation waveform is received is also conceivable.

Furthermore, variations of modulation of a transmission signal constituting a transmission wave to be emitted set for a scenario may include, for example, a continuous wave (CW), a frequency modulated continuous wave (FMCW), a phase modulated continuous wave (PMCW), a pulsed waveform, a level, and with or without modulation.

Moreover, variations of a transmission signal constituting a transmission wave to be emitted set for a scenario may include variations other than modulation, and for example, antenna polarization (vertical, horizontal, oblique, circle, and type and angle) may be added to the variations.

Furthermore, in the above description, the example where a scenario is set on the basis of information specifying a space in the virtual running environment and information specifying a transmission wave of a millimeter-wave radar, such as whether or not the millimeter-wave radar is the same in model, whether or not the millimeter-wave radar is the same in modulation method, and whether or not the millimeter-wave radar is the same in antenna polarization has been described, or alternatively, the scenario may be set on the basis of other information, and specifically, the scenario may be set on the basis of information specifying the model of the millimeter-wave radar.

For example, the model of a millimeter-wave radar mounted on each vehicle is identified to some extent on the basis of a vehicle model, so that a scenario may be set on the basis of the model of a vehicle present around the vehicle in the virtual space in which the vehicle is running. In this case, it is possible to substantially identify, by identifying the vehicle model, a type such as the model of a millimeter-wave radar, the modulation method or antenna polarization of a transmission wave, and the like.

Furthermore, it is assumed that a scenario and an interference signal model correspond to each other. Therefore, when a predetermined interference signal model is set, a corresponding scenario is set in principle; conversely, when a scenario is set, a corresponding interference signal model is set in principle. Note that there is a possibility that, even for different scenarios, the same interference signal model is set, so that scenarios and interference signal models are not necessarily in one-to-one correspondence.

Moreover, for example, a scenario where the millimeter-wave radar mounted on the vehicle 111 illustrated in FIG. 7 is the same in model as the millimeter-wave radar mounted on the vehicle 101-1, and the transmission signal of the emitted transmission wave Sf1 and the transmission signal of the reflected wave Sr are the same is also conceivable.

In such a case, the millimeter-wave radar of the vehicle 101-1 receives not only the signal represented by the waveform Wr but also an interference signal having a waveform as represented by a waveform Wf1-2 corresponding to the transmission wave Sf1, as illustrated in FIG. 9.

That is, in FIG. 9, the interference signal of the waveform Wf1-2 that is the same in chirp modulation slope as the waveform Wt is mixed in addition to the signal represented by the waveform Wr.

As illustrated in FIG. 7, a situation where when the vehicle 101-1 follows the vehicle 101-2, the vehicle 111 that is an oncoming vehicle equipped with a different millimeter-wave radar is present, and the different millimeter-wave radar mounted on the vehicle 111 emits the transmission wave Sf1 based on the transmission signal that is the same in chirp modulation slope as the transmission signal Si is considered as one scenario.

Under this scenario, an interference signal model that receives not only the reception signal represented by the waveform Wr, but also the interference signal corresponding to the transmission wave Sf1 as represented by the waveform Wf1-2 illustrated in FIG. 9 is set.

As illustrated in FIG. 7, a scenario based on a situation where when the vehicle 101-1 follows the vehicle 101-2, the vehicle 111 that is an oncoming vehicle equipped with a different millimeter-wave radar is present, and the different millimeter-wave radar mounted on the vehicle 111 emits the transmission wave Sf1 based on the transmission signal that is the same in chirp modulation slope as the transmission signal Si is hereinafter referred to as second scenario.

Furthermore, an interference signal model that is set for the second scenario and receives not only the reception signal represented by the waveform Wr, but also the interference signal corresponding to the transmission wave Sf1 as represented by the waveform Wf1-2 illustrated in FIG. 9 is referred to as second interference signal model.

Moreover, for example, a scenario where the millimeter-wave radar mounted on the vehicle 111 illustrated in FIG. 7 emits a transmission wave Sf1 that is not chirp-modulated, unlike the millimeter-wave radar mounted on the vehicle 101 is also conceivable.

Under this scenario, the millimeter-wave radar of the vehicle 101-1 receives not only the signal represented by the waveform Wr, but also an interference signal having a waveform as represented by a waveform Wf1-3 as illustrated in FIG. 10.

That is, in FIG. 10, not only the signal represented by the waveform Wr, but also the interference signal of the waveform Wf1-3 that has a waveform of a predetermined frequency and is not chirp-modulated is received.

As illustrated in FIG. 7, a situation where when the vehicle 101-1 follows the vehicle 101-2, the vehicle 111 that is an oncoming vehicle equipped with a different millimeter-wave radar is present, and the different millimeter-wave radar mounted on the vehicle 111 emits the transmission wave Sf1 that is not chirp-modulated is also considered as one scenario.

Under this scenario, an interference signal model including not only the reception signal represented by the waveform Wr, but also the interference signal corresponding to the transmission wave Sf1 as represented by the waveform Wf1-3 illustrated in FIG. 10 is set.

As illustrated in FIG. 7, a scenario based on a situation where when the vehicle 101 follows the vehicle 101-2, the vehicle 111 that is an oncoming vehicle equipped with a different millimeter-wave radar is present, and the different millimeter-wave radar mounted on the vehicle 111 emits the transmission wave Sf1 based on the transmission signal that is not chirp-modulated is hereinafter referred to as third scenario.

Furthermore, an interference signal model that is set for the third scenario and includes not only the reception signal represented by waveform Wr, but also the interference signal corresponding to the transmission wave Sf1 as represented by the waveform Wf1-3 illustrated in FIG. 10 is referred to as third interference signal model.

In the present disclosure, the above-described situations where various interference signals are generated are set scenarios, a millimeter-wave radar model is generated on the basis of an interference signal model set for each scenario, and automated driving simulation by the generated millimeter-wave radar model is performed.

It is therefore possible to build millimeter-wave models based on various interference signal models by setting anticipated realistic running situations as various scenarios, and it is possible to achieve realistic and highly accurate automated driving simulation.

### 3. APPLICATION EXAMPLE OF SIMULATION SCENARIO AND INTERFERENCE SIGNAL MODEL

In the above description, the case where a millimeter-wave radar directly receives a transmission wave that generates an interference signal from a different millimeter-wave radar as a transmission source such as an oncoming vehicle has been described, but a case where the transmission wave is reflected off an object different from the object to be ranged and is indirectly received may be assumed.

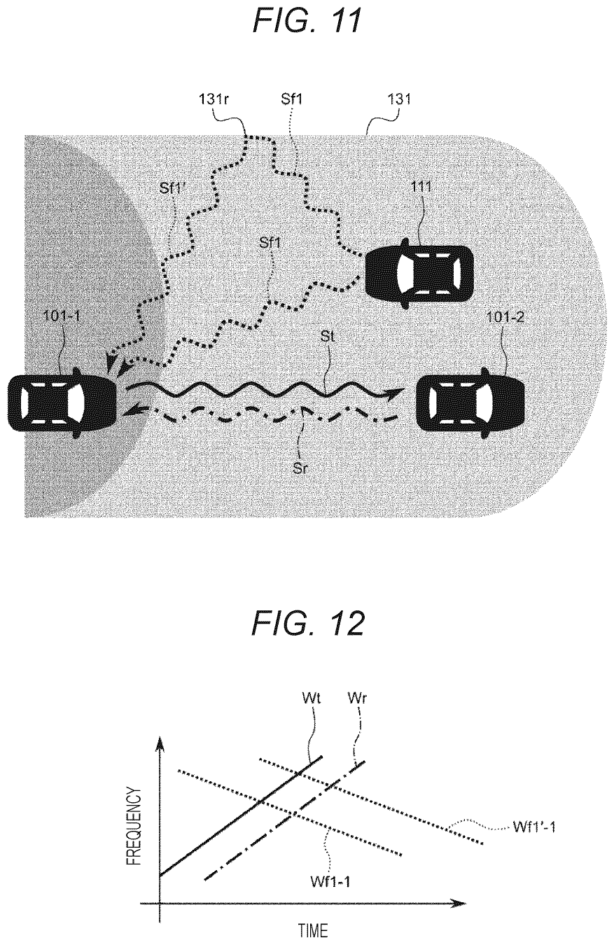

FIG. 11 illustrates an example of a scenario where the situation as described with reference to FIG. 7 where the vehicle 101-1 is running to the right of the drawing together with the vehicle 101-2 that is a preceding vehicle, and the vehicle 111 is running in the opposite lane to the left of the drawing while facing the vehicle 101-1 occurs in a tunnel 131.

Under the scenario illustrated in FIG. 11, the millimeter-wave radar of the vehicle 101 directly receives the transmission wave Sf1 emitted from the vehicle 111 in addition to the reflected wave Sr from the vehicle 102 and indirectly receives a reflected wave Sf1′ of the transmission wave Sf1 emitted from the vehicle 111, the reflected wave Sf1′ being reflected off a wall 131r of the tunnel 131.

Here, consider a case where a different millimeter-wave radar mounted on the vehicle 111 that is an oncoming vehicle is different in model from the millimeter-wave radar mounted on the vehicle 101, and emits the transmission wave Sf1 based on a transmission signal different in chirp modulation slope from the transmission signal Si, for example.

In this case, as illustrated in FIG. 12, the millimeter-wave radar of the vehicle 101-1 receives not only the reception signal represented by the waveform Wr, but also the interference signal corresponding to the transmission wave Sf1 as represented by the waveform Wf1-1 and a waveform Wf1′-1 corresponding to the reflected wave Sf1′, for example.

As described above, in principle, the IF signal is obtained as a result of mixing the signals represented by the waveforms Wt and Wr, and the distance from the vehicle 101-1 to the vehicle 101-2 is measured on the basis of the IF frequency (beat frequency) of the obtained IF signal.

Here, since the interference signal corresponding to the transmission wave Sf1 as represented by the waveform Wf1-1 illustrated in FIG. 12 and the waveform Wf1′-1 corresponding to the reflected wave Sf1′ are, however, mixed with the reception signal of the waveform Wr, an error also occurs in the IF frequency (beat frequency) of the generated IF signal, and there is a possibility that the accuracy of the measured distance from the vehicle 101-1 to the vehicle 101-2 deteriorates.

That is, the example in FIG. 12 illustrates an example of a case where the chirp modulation slope of the waveform Wf1-1 representing the transmission signal of the transmission wave Sf1 emitted from the millimeter-wave radar mounted on the vehicle 111 is different from the slope of the waveform Wt representing the transmission signal Si of the transmission wave St emitted from the millimeter-wave radar mounted on the vehicle 101-1.

Note that the reflected wave Sf1′ received by the vehicle 101-1 reaches the vehicle 101-1 via the wall 131r of the tunnel 131 and is thus longer in path than the transmission wave Sf1, so that the waveform Wf1′-1 including the corresponding reception signal is received with a delay relative to the waveform Wf1-1.

As illustrated in FIG. 11, a situation where when the vehicle 101-1 follows the vehicle 101-2 in the tunnel 131, the vehicle 111 that is an oncoming vehicle equipped with a different millimeter-wave radar is present, and the different millimeter-wave radar mounted on the vehicle 111 emits the transmission wave Sf1 based on the transmission signal different in chirp modulation slope from the transmission signal Si can be considered as one scenario.

Under the scenario in FIG. 11, an interference signal model that receives not only the reception signal represented by the waveform Wr, but also the interference signal corresponding to the transmission wave Sf1 as represented by the waveform Wf1-1 illustrated in FIG. 12 and the interference signal corresponding to the reflected wave Sf1′ as represented by the waveform Wf1′-1 illustrated in FIG. 12 is set.

As illustrated in FIG. 11, a scenario based on a situation where when the vehicle 101-1 follows the vehicle 101-2 in the tunnel 131, the vehicle 111 that is an oncoming vehicle equipped with a different millimeter-wave radar is present, and the different millimeter-wave radar mounted on the vehicle 111 emits the transmission wave Sf1 based on the transmission signal different in chirp modulation slope from the transmission signal Si is hereinafter referred to as fourth scenario.

Furthermore, an interference signal model that is set for the fourth scenario and includes not only the reception signal represented by the waveform Wr, but also the interference signal corresponding to the transmission wave Sf1 as represented by the waveform Wf1-1 illustrated in FIG. 12 and the interference signal corresponding to the reflected wave Sf1′ as represented by the waveform Wf1′-1 illustrated in FIG. 12 is referred to as fourth interference signal model.

Moreover, for example, a scenario where the millimeter-wave radar mounted on the vehicle 111 illustrated in FIG. 11 is the same in model as the millimeter-wave radar mounted on the vehicle 101, and the transmission signal of the emitted transmission wave Sf1 and the transmission signal of the emitted transmission wave St are the same is also conceivable.

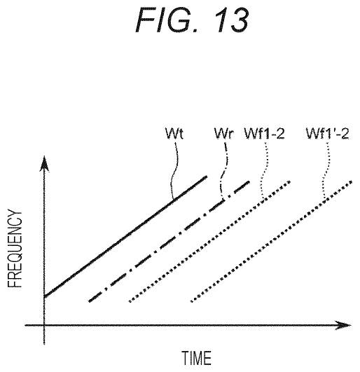

In such a case, as illustrated in FIG. 13, the millimeter-wave radar of the vehicle 101 receives not only the signals represented by the waveforms Wt and Wr, but also an interference signal having a waveform corresponding to the transmission wave Sf1 that is directly received as represented by a waveform Wf1-2, and an interference signal having a waveform corresponding to the reflected wave Sf1′ that is indirectly received as represented by a waveform Wf1′-2.

That is, in FIG. 13, the interference signals of the waveforms Wf1-2 and Wf1′-2 that are the same in slope as the waveform Wt are received in addition to the signal represented by the waveform Wr.

As illustrated in FIG. 11, a situation where when the vehicle 101-1 follows the vehicle 101-2 in the tunnel 131, the vehicle 111 that is an oncoming vehicle equipped with a different millimeter-wave radar is present, and the different millimeter-wave radar mounted on the vehicle 111 emits the transmission wave Sf1 based on the transmission signal that is the same in chirp modulation slope as the transmission signal Si is considered as one scenario.

Under this scenario, an interference signal model that receives not only the reception signal represented by the waveform Wr, but also the interference signal corresponding to the transmission wave Sf1 as represented by the waveform Wf1-2 illustrated in FIG. 13 and interference signal corresponding to the reflected wave Sf1′ as represented by the waveform Wf1′-2 illustrated in FIG. 13 is set.

As illustrated in FIG. 11, a scenario based on a situation where when the vehicle 101-1 follows the vehicle 101-2 in the tunnel 131, the vehicle 111 that is an oncoming vehicle equipped with a different millimeter-wave radar is present, and the different millimeter-wave radar mounted on the vehicle 111 emits the transmission wave Sf1 based on the transmission signal that is the same in chirp modulation slope as the transmission signal Si is hereinafter referred to as fifth scenario.

Furthermore, an interference signal model that is set for the fifth scenario and receives not only the reception signal represented by the waveform Wr, but also the interference signals corresponding to the transmission wave Sf1 and the reflected wave Sf1′ as represented by the waveforms Wf1-2 and Wf1′-2 illustrated in FIG. 13 is referred to as fifth interference signal model.

Moreover, for example, a scenario where the millimeter-wave radar mounted on the vehicle 111 illustrated in FIG. 11 emits a transmission wave Sf1 that is not chirp-modulated, unlike the millimeter-wave radar mounted on the vehicle 101-1, is also conceivable.

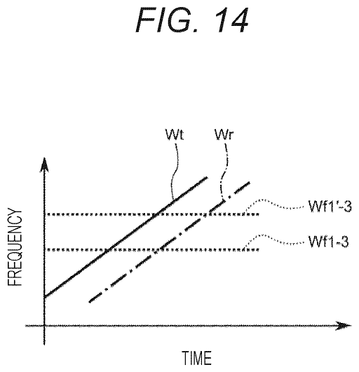

Under this scenario, the millimeter-wave radar of the vehicle 101-1 receives not only the signal represented by the waveform Wr, but also an interference signal having a waveform as represented by a waveform Wf1-3 and an interference signal having a waveform as represented by a waveform Wf1′-3, as illustrated in FIG. 14.

That is, in FIG. 14, the interference signal of the waveform Wf1-3 corresponding to the transmission wave Sf1 having a waveform of a predetermined frequency and the interference signal of the waveform Wf1′-3 corresponding to the reflected wave Sf1′ are received in addition to the signal represented by the waveform Wr.

As illustrated in FIG. 11, a situation where when the vehicle 101-1 follows the vehicle 101-2 in the tunnel 131, the vehicle 111 that is an oncoming vehicle equipped with a different millimeter-wave radar is present, and the different millimeter-wave radar mounted on the vehicle 111 emits the transmission wave Sf1 that is not chirp-modulated is also considered as one scenario.

Under this scenario, an interference signal model including not only the reception signal represented by the waveform Wr, but also the interference signals corresponding to the transmission wave Sf1 as represented by the waveforms Wf1-3 and Wf1′-3 illustrated in FIG. 14 is set.

As illustrated in FIG. 11, a scenario based on a situation where when the vehicle 101-1 follows the vehicle 101-2 in the tunnel 131, the vehicle 111 that is an oncoming vehicle equipped with a different millimeter-wave radar is present, and the different millimeter-wave radar mounted on the vehicle 111 emits the transmission wave Sf1 based on the transmission signal that is not chirp-modulated is hereinafter referred to as sixth scenario.

Furthermore, an interference signal model that is set for the sixth scenario and includes not only the reception signal represented by the waveform Wr, but also the interference signal corresponding to the transmission wave Sf1 as represented by the waveform Wf1-3 illustrated in FIG. 14 and the interference signal corresponding to the reflected wave Sf1′ as represented by the waveform Wf1′-3 illustrated in FIG. 14 is referred to as sixth interference signal model.

In the present disclosure, the above-described scenarios and interference signal models each set for a corresponding one of the scenarios are stored in advance, and when automated driving simulation is performed, a scenario corresponding to a running environment anticipated when a vehicle runs is read, and a millimeter-wave radar model is built on the basis of an interference signal model corresponding to the scenario, so that simulation of a millimeter-wave radar for automated driving is performed.

Hitherto, various running conditions have been constructed and simulated in a pseudo manner by varying parameters for adjusting the number and direction of transmission signals and reception signals; however, there is a possibility that a running environment constructed by varying the parameters includes a running environment that does not actually exist, and as a result, there is a possibility that simulation in a running environment that actually exists cannot be sufficiently performed.

On the other hand, in the present disclosure, it is possible to set a situation that is likely to occur as a scenario, set an interference signal model corresponding to the scenario, and repeat simulation, so that it is possible to achieve the simulation by highly reproducing a realistic running environment.

Furthermore, even if simulation is required for a situation that is unlikely to occur, it is possible to appropriately achieve the simulation by setting a scenario that is unlikely to occur but requires simulation and setting a corresponding interference signal model.

### 4. PREFERRED EMBODIMENT

### <Configuration Example of Automated Driving Simulator>

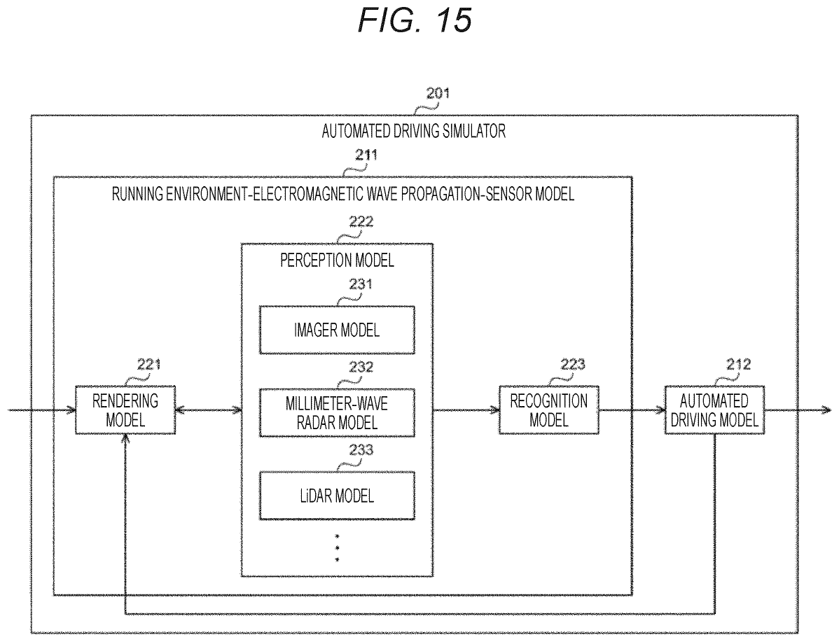

Next, an automated driving simulator to which the technology of the present disclosure is applied will be described with reference to FIG. 15.

An automated driving simulator 201 illustrated in FIG. 15 is a system that performs simulation of an automated driving system that enables automated driving and evaluates and verifies safety and the like of the automated driving system. The automated driving simulator 201 includes a running environment-electromagnetic wave propagation-sensor model 211 and an automated driving model 212.

The running environment-electromagnetic wave propagation-sensor model 211 includes a rendering model 221, a perception model 222, and a recognition model 223.

The rendering model 221 is a model that simulates an environment where a vehicle runs in a virtual running test and simulates an electromagnetic wave (for example, visible light, infrared light, a radio wave, or the like) propagated to various sensors included in a vehicle in the simulated environment.

For example, the rendering model 221 simulates an environment where the vehicle runs on the basis of a 3D model of the vehicle to be subjected to the virtual running test, properties of various objects, a scenario of the virtual running test, and the like. The properties of an object include, for example, a type, a size, a shape, a texture (surface properties), reflection properties, and the like. The scenario of the virtual running test includes, for example, a route on which the vehicle runs and conditions of a virtual space around the vehicle on the route. The conditions of the virtual space include, for example, locations and motions of various objects (including a person), a time zone, weather, a road surface condition, and the like.

The rendering model 221 simulates an electromagnetic wave propagating from the virtual space around the vehicle to the various sensors included in the vehicle in the simulated environment. The electromagnetic wave further includes a reflected wave (for example, a reflected wave of a millimeter-wave radar or the like) of an electromagnetic wave virtually emitted from the perception model 222 to the surroundings of the vehicle. The rendering model 221 provides the perception model 222 with rendering data including data representing the simulated electromagnetic wave.

For example, for a millimeter-wave radar, the rendering model 221 simulates a millimeter wave propagated from the virtual space around the vehicle set in advance in accordance with the scenario, and stores the simulated millimeter wave in association with the scenario. Then, subsequently, the rendering model 221 reads an interference signal model corresponding to the scenario, and outputs the interference signal model as data representing the simulated electromagnetic wave.

The perception model 222 is a model that simulates a perception step of the automated driving system. For example, the perception model 222 simulates perception processing of perceiving the surroundings (for example, surrounding objects) of the vehicle with various sensors on the basis of the electromagnetic waves simulated by the rendering model 221. The perception model 222 generates perception data representing a result of the perception of the surroundings of the vehicle, and supplies the perception data to the recognition model 223.

The perception model 222 includes models corresponding to sensors that are included in the vehicle and each perceive an object by means of an electromagnetic wave, for example. For example, the perception model 222 includes an imager model 231, a millimeter-wave radar model 232, a light detection and ranging (LiDAR) model 233, and the like. Note that although the perception model 222 has a configuration that allows the perception model 222 to further include a model other than the imager model 231, the millimeter-wave radar model 232, and the LiDAR model 233, for example, the following description will be given on the assumption that the perception model 222 includes the imager model 231, the millimeter-wave radar model 232, and the LiDAR model 233.

The imager model 231 is a model that performs simulation of an imager (image sensor) included in the vehicle. For example, the imager model 231 generates a captured image obtained by capturing an image of the virtual space around the vehicle (hereinafter, referred to as virtual captured image) on the basis of light (incident light) included in the electromagnetic wave simulated by the rendering model 221. The imager model 231 supplies, to the recognition model 223, virtual captured image data that is a kind of the perception data and corresponds to the virtual captured image.

The millimeter-wave radar model 232 is a model that performs simulation of a millimeter-wave radar included in the vehicle. The millimeter-wave radar model 232 simulates, for example, processing of transmitting a millimeter-wave signal as a transmission wave to the surroundings of the vehicle within a predetermined range, receiving a reflected wave, and generating an intermediate frequency (IF) signal by mixing the transmission wave and the reception wave. The millimeter-wave radar model 232 supplies, to the recognition model 223, an IF signal (hereinafter, referred to as virtual IF signal) that is a kind of the perception data.

More specifically, the millimeter-wave radar model 232 acquires an interference signal model set in accordance with the scenario as a simulation result of the electromagnetic wave including the millimeter-wave signal supplied from the rendering model 221 and propagated to the millimeter-wave radar, and simulates processing of generating an intermediate frequency (IF) signal by mixing a reception wave based on the interference signal model and a transmission wave.

The LiDAR model 233 is a model that performs simulation of LiDAR included in the vehicle. The LiDAR model 233 simulates, for example, processing of irradiating the predetermined range of the surroundings of the vehicle with laser light, receiving reflected light of the laser light, and generating point cloud data on the basis of the reflected light. The LiDAR model 233 supplies, to the recognition model 223, the point cloud data (hereinafter, referred to as virtual point cloud data) that is a kind of the perception data.

The recognition model 223 is a model that simulates a recognition step of the automated driving system. For example, the recognition model 223 simulates processing of recognizing the surroundings of the vehicle on the basis of the virtual image data, the virtual IF signal, the virtual point cloud data, and the like. For example, the recognition model 223 recognizes the respective types, locations, sizes, shapes, motions, and the like of various objects (including a person) around the vehicle. The recognition model 223 supplies, to the automated driving model 112, data representing a recognition result (hereinafter, referred to as virtual recognition data).

Note that the recognition model 223 may perform, on a sensor-by-sensor basis, the recognition processing on the basis of the perception data for each sensor to generate the virtual recognition data for each sensor, or may perform fusion (sensor fusion) on the perception data for each sensor and perform the recognition processing on the basis of the fused perception data.

The automated driving model 212 is a model that simulates a determination step and an operation step of the automated driving system. For example, the automated driving model 212 determines the surroundings of the vehicle on the basis of the virtual recognition data and simulates processing of predicting a risk that the vehicle will encounter. For example, the automated driving model 212 simulates processing of creating an action plan such as a running route on the basis of the planned route, the predicted risk, and the like. For example, the automated driving model 212 simulates processing of performing automated operation on the vehicle on the basis of the created action plan.

The automated driving model 212 feeds information indicating virtual surroundings of the vehicle back to the rendering model 221. The virtual surroundings of the vehicle include, for example, running conditions of the vehicle (for example, a speed, a direction, braking, and the like), a running location of the vehicle, and the like.

Note that, for example, in a case where the virtual recognition data is separately supplied for each sensor type from the recognition model 223, the automated driving model 212 performs fusion (sensor fusion) on the recognition result represented by each virtual recognition data.

### <Configuration Example of Rendering Model>

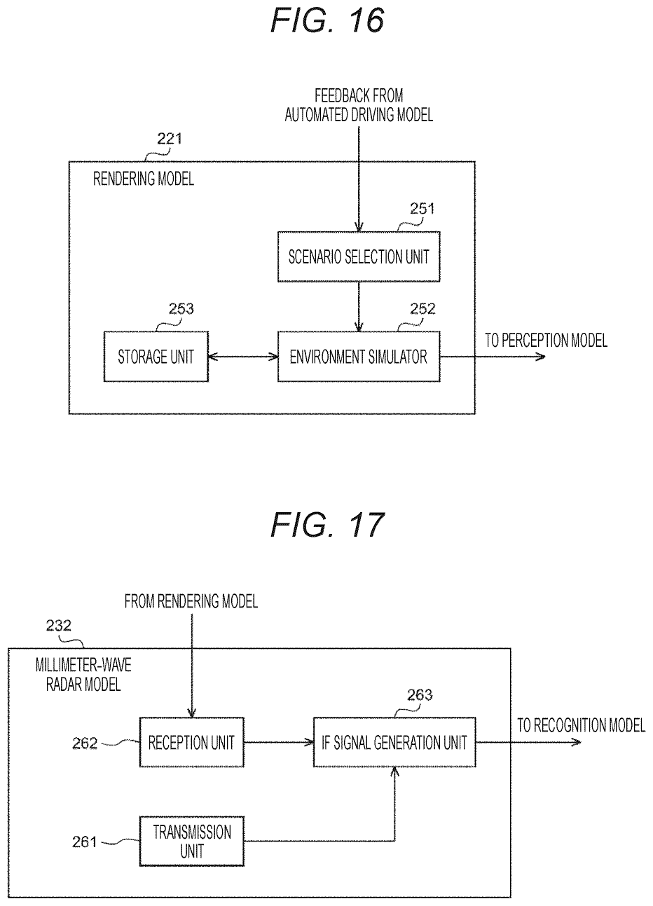

Next, a configuration example of the rendering model 221 will be described with reference to FIG. 16.

The rendering model 221 includes a scenario selection unit 251, an environment simulator 252, and a storage unit 253.

The scenario selection unit 251 selects a scenario in accordance with the route on which the vehicle runs and the conditions of the virtual space around the vehicle on the route, and outputs information regarding the selected scenario to the environment simulator 252. Here, the conditions of the virtual space include, for example, the respective locations and motions of various objects (including a person), a time zone, weather, a road surface condition, and the like.

The environment simulator 252 simulates an environment where the vehicle runs in a virtual running test corresponding to the scenario supplied from the scenario selection unit 251, simulates an electromagnetic wave (for example, visible light, infrared light, a radio wave, or the like) propagated to various sensors included in the vehicle in the simulated environment, and outputs data representing the simulated electromagnetic wave to the perception model 222.

At this time, the environment simulator 252 stores the data representing the simulated electromagnetic wave into the storage unit 253 in accordance with the scenario.

Accordingly, when the same scenario as the scenario selected before is selected, the environment simulator 252 reads data representing the simulated electromagnetic wave stored in the storage unit 253 in association with the scenario, and outputs the data to the perception model 222.

Here, for the millimeter-wave radar, data representing the electromagnetic wave simulated in accordance with the environment where the vehicle runs in the virtual running test simulated in accordance with the scenario corresponds to the above-described interference signal model.

That is, regarding the millimeter-wave radar, the environment simulator 252 simulates the environment where the vehicle runs in the virtual running test on the basis of the scenario selected by the scenario selection unit 251, then simulates an electromagnetic wave including a millimeter-wave signal as an interference signal model, outputs the simulated electromagnetic wave to the perception model 222, and stores the simulated electromagnetic wave into the storage unit 253 in association with the scenario.

Then, subsequently, when the scenario selection unit 251 selects the simulated scenario, the environment simulator 252 reads the interference signal model stored in association with the selected scenario from the storage unit 253, and outputs the interference signal model to the perception model 222.

### <Configuration Example of Millimeter-Wave Radar Model>

Next, a configuration example of the millimeter-wave radar model 232 will be described with reference to FIG. 17.

The millimeter-wave radar model 232 includes a transmission unit 261, a reception unit 262, and an IF signal generation unit 263.

The transmission unit 261 simulates a transmission wave including a millimeter-wave signal emitted from the millimeter-wave radar including the transmission signal Si, and outputs the simulated transmission wave to the IF signal generation unit 263. Here, the simulated transmission wave is a waveform of the transmission wave and is a waveform of the waveform Wt corresponding to the above-described transmission signal Si.

The reception unit 262 simulates a reception wave received as a reflected wave while the vehicle is running in the virtual space in the virtual running test on the basis of the signal supplied from the rendering model 221, the signal indicating an electromagnetic wave related to the millimeter-wave signal corresponding to the selected scenario, that is, the interference signal model, and outputs the simulated reception wave to the IF signal generation unit 263. Here, the simulated reception wave substantially corresponds to the waveforms Wr, Wf1, and Wf1′ described above.

The IF signal generation unit 263 generates an IF signal by mixing the transmission wave supplied from the transmission unit 261 and the reception wave supplied from the reception unit 262, and outputs the IF signal as a virtual IF signal to the recognition model 223.

### <Automated Driving Simulation Processing>

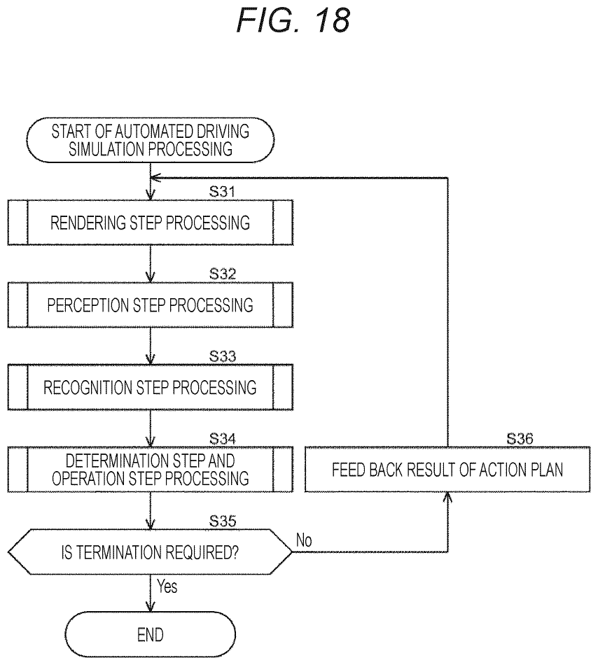

Next, automated driving simulation processing performed by the automated driving simulator 201 in FIG. 15 will be described with reference to a flowchart in FIG. 18.

In step S31, the rendering model 221 performs rendering step processing to simulate an environment where the vehicle runs on the basis of the 3D model of the vehicle to be subjected to the virtual running test, the properties of various objects, and the scenario of the virtual running test.

Furthermore, the rendering model 221 simulates an electromagnetic wave propagating from the virtual space around the vehicle to various sensors included in the vehicle on the basis of the simulated environment where the vehicle runs, and outputs data on the electromagnetic wave to the perception model 222.

Here, for the millimeter-wave radar, the rendering model 221 selects the 3D model of the vehicle to be subjected to the virtual running test, the properties of various objects, and the scenario of the virtual running test, and outputs a radio wave interference model to the millimeter-wave radar model 232 of the perception model 222 as millimeter-wave data that is an electromagnetic wave propagating to a millimeter-wave sensor on the basis of the environment where the vehicle runs corresponding to the selected scenario.

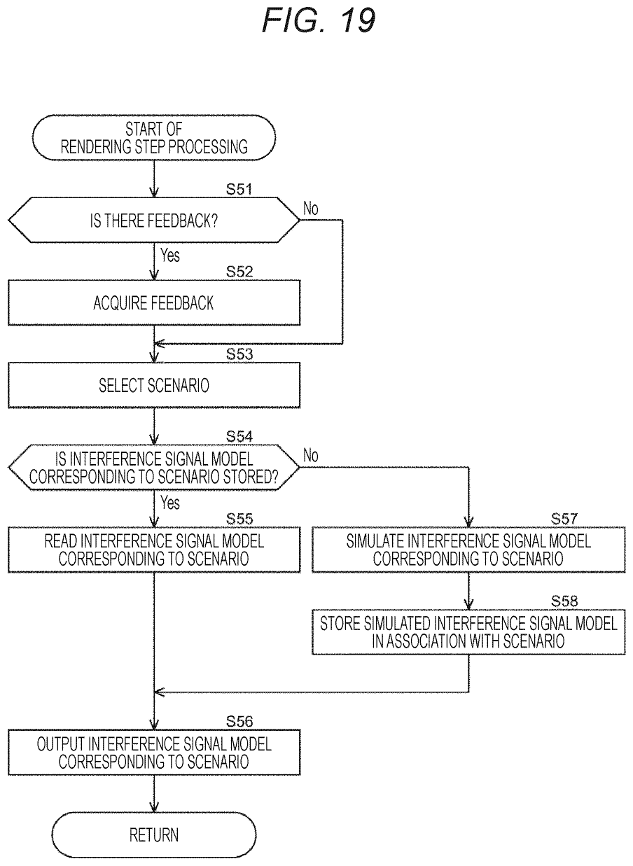

Note that the rendering step processing related to the millimeter-wave radar will be described later in detail with reference to the flowchart in FIG. 19.

In step S32, the perception model 222 performs perception step processing to simulate perception processing of perceiving the surroundings (for example, surrounding objects) of the vehicle with various sensors on the basis of data on the electromagnetic wave simulated by the rendering model 221.

The perception model 222 generates perception data representing a result of the perception of the surroundings of the vehicle, and supplies the perception data to the recognition model 223.

Here, the millimeter-wave radar model 232 of the perception model 222 generates a reception wave on the basis of the radio wave interference model as the millimeter-wave data that is the electromagnetic wave propagating to the millimeter-wave sensor, mixes the reception wave with a transmission wave to generate an IF signal, and outputs the IF signal to the recognition model 223 as a virtual IF signal.

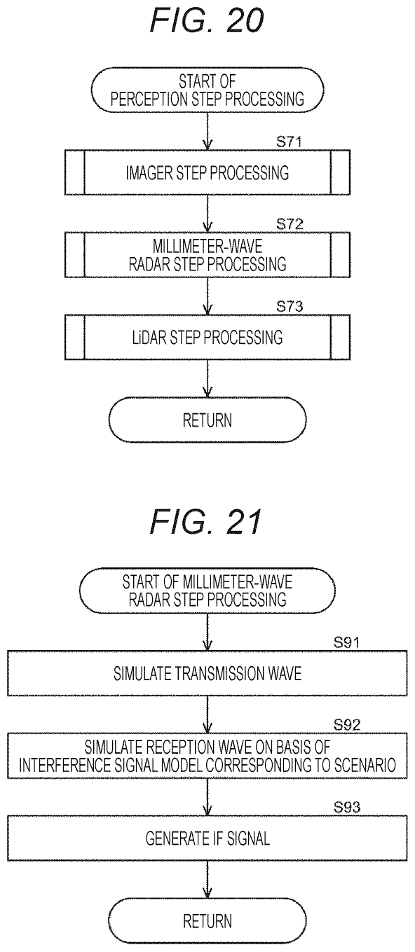

Note that the perception step processing will be described later in detail with reference to the flowchart in FIG. 20. Furthermore, the millimeter-wave radar step processing that is processing related to the millimeter-wave radar in the perception step processing will be described later in detail with reference to the flowchart in FIG. 21.

In step S33, the recognition model 223 simulates processing of recognizing the surroundings of the vehicle on the basis of the virtual image data, the virtual IF signal, the virtual point cloud data, and the like, and outputs the recognition result to the automated driving model 212 as virtual recognition data.

In step S34, the automated driving model 212 performs determination step and operation step processing of the automated driving system, determines the surroundings of the vehicle on the basis of the virtual recognition data, simulates processing of predicting a risk that the vehicle will encounter, creates an action plan such as a running route on the basis of the planned route, the predicted risk, and the like, and simulates processing of performing automated operation on the vehicle on the basis of the created action plan.

In step S35, the automated driving model 212 determines whether or not an instruction for terminating the automated driving simulation processing has been made, and in a case where the termination instruction has not been made, the processing proceeds to step S36.

In step S36, the automated driving model 212 feeds information indicating virtual surroundings of the vehicle such as running conditions of the vehicle (for example, a speed, a direction, braking, and the like) and a running location of the vehicle back to the rendering model 221, and the processing returns to step S31.

Then, in a case where an instruction for terminating the automated driving simulation processing has been made in step S35, the processing is brought to an end.

Through the above-described processing, the automated driving simulation is performed.

### <Rendering Step Processing>

Next, the rendering step processing performed by the rendering model 221 will be described with reference to the flowchart in FIG. 19.

In step S51, the scenario selection unit 251 determines whether or not there is feedback of information indicating the virtual surroundings of the vehicle such as the most recent running conditions of the vehicle and the most recent running location of the vehicle from the automated driving model 212.

Whereas, in a case where it is determined in step S51 that there is feedback, the processing proceeds to step S52. In step S52, the scenario selection unit 251 acquires the feedback of information indicating the virtual surroundings of the vehicle such as the most recent running conditions of the vehicle and the most recent running location of the vehicle from the automated driving model 212.

Note that, in a case where there is no feedback in step S51, the processing of step S52 is skipped.

In step S53, the scenario selection unit 251 selects a scenario on the basis of the information indicating the virtual surroundings of the vehicle, and outputs the scenario to the environment simulator 252. Here, in a case where there is feedback indicating the most recent virtual surroundings of the vehicle, the scenario selection unit 251 selects a scenario on the basis of the feedback. Furthermore, in a case where there is no feedback, the scenario selection unit 251 selects a scenario on the basis of, for example, information regarding the start point of the running route, and outputs the scenario to the environment simulator 252.

In step S54, the environment simulator 252 accesses the storage unit 253 to search for an interference signal model corresponding to the scenario, and determines whether or not the interference signal model corresponding to the scenario is stored.

In a case where it is determined in step S54 that the interference signal model corresponding to the scenario has been stored, the processing proceeds to step S55.

In step S55, the environment simulator 252 reads the interference signal model corresponding to the scenario stored in the storage unit 253.

In step S56, the environment simulator 252 outputs the interference signal model corresponding to the scenario to the millimeter-wave radar model 232 of the perception model 222 as data on the simulated electromagnetic wave.

On the other hand, in a case where it is determined in step S54 that the interference signal model corresponding to the scenario has not been stored, the processing proceeds to step S57.

In step S57, the environment simulator 252 simulates a propagating millimeter wave as an interference signal model on the basis of a virtual running environment of the vehicle specified by the scenario.

In step S58, the environment simulator 252 stores the simulated interference signal model into the storage unit 253 in association with the scenario, and the processing proceeds to step S56.

Through the above-described processing, it is possible to select a scenario on the basis of the virtual surroundings of the vehicle such as the most recent running conditions of the vehicle and the most recent running location of the vehicle, render an interference signal model corresponding to the selected scenario as data on the simulated electromagnetic wave, and output the interference signal model to the perception model 222.

That is, in a case where the first to sixth interference signal models have been stored in the storage unit 253 in association with the first to sixth scenarios described above, for example, when the third scenario is selected, the corresponding third interference signal model is read and supplied to the millimeter-wave radar model 232 of the perception model 222.

Note that, in the present disclosure, the example where an interference signal model corresponding to a scenario is supplied to the millimeter-wave radar model 232 has been given for the description of the rendering step processing, but corresponding processing is also performed on the imager model 231 and the LiDAR model 233.

### <Perception Step Processing>

Next, the perception step processing performed by the perception model 222 will be described with reference to a flowchart in FIG. 20.

In step S71, the imager model 231 performs imager step processing to generate a virtual captured image obtained by capturing an image of the virtual space around the vehicle on the basis of light (incident light) included in the electromagnetic wave simulated by the rendering model 221 and supply corresponding virtual captured image data to the recognition model 223.

In step S72, the millimeter-wave radar model 232 performs the millimeter-wave radar step processing to acquire the interference signal model supplied from the rendering model 221, generate a virtual IF signal by mixing a reception wave based on the interference signal model and a transmission wave, and supply the virtual IF signal to the recognition model 223.

Note that the millimeter-wave radar step processing will be described later in detail with reference to the flowchart in FIG. 21.

In step S73, the LiDAR model 233 performs LiDAR step processing to, for example, irradiate the predetermined range of the surroundings of the vehicle with laser light, receive reflected light of the laser light, simulate virtual point cloud data, which is a kind of the perception data, on the basis of the reflected light, and supply the simulated virtual point cloud data to the recognition model 223.

Through the series of processing described above, the perception data is simulated on the basis of the electromagnetic wave data of various sensors and supplied to the recognition model 223.

### <Millimeter-Wave Radar Step Processing>

Next, the millimeter-wave radar step processing performed by the millimeter-wave radar model 232 will be described with reference to a flowchart in FIG. 21.

In step S91, the transmission unit 261 of the millimeter-wave radar model 232 simulates a transmission wave including the millimeter-wave signal emitted by the millimeter-wave radar and outputs the simulated transmission wave to the IF signal generation unit 263.

In step S92, the reception unit 262 simulates a reception wave received as a reflected wave while the vehicle is running in the virtual space in the virtual running test on the basis of the interference signal model supplied from the rendering model 221 and corresponding to the selected scenario, and outputs the simulated reception wave to the IF signal generation unit 263.

In step S93, the IF signal generation unit 263 generates an IF signal by mixing the transmission wave supplied from the transmission unit 261 and the reception wave supplied from the reception unit 262, and outputs the IF signal as a virtual IF signal to the recognition model 223.

Through the above-described processing, a reception wave received as the reflected wave while the vehicle is running in the virtual space is simulated on the basis of the interference signal model corresponding to the selected scenario, the simulated reception wave is mixed with a transmission wave to generate a virtual IF signal, and the virtual IF signal is supplied to the recognition model 223 as one pieces of the perception data.

Furthermore, through the series of processing described above, in a case where there is no interference signal model corresponding to the scenario, an interference signal model is generated by means of simulation based on a virtual running environment of the vehicle specified by the scenario and is stored into the storage unit 253 in association with the scenario.

As a result, for the interference signal model corresponding to the scenario, once simulation has been performed to generate an interference signal model for each scenario, it is only necessary to read the interference signal model corresponding to the scenario and supply the interference signal model to the perception model 222, so that simulation is not required and it is possible to reduce a processing load and improve a processing speed.

Moreover, since an interference signal model is generated by means of simulation on the basis of a scenario, it is possible to reproduce a virtual running environment in accordance with reality, and it is therefore possible to achieve more accurate automated driving simulation.

Through the series of processing described above, in the simulation of the millimeter-wave radar, a reception wave including an interference signal is modeled and set as an interference signal model for each scenario, so that it is possible to achieve, by using the interference signal model corresponding to the scenario, highly accurate simulation in accordance with to a real running environment.

### 5. EXAMPLE OF EXECUTION BY SOFTWARE

Incidentally, the series of processing described above can be performed by hardware, but can also be performed by software. In a case where the series of processing is performed by software, a program constituting the software is installed from a recording medium into, for example, a computer built into dedicated hardware or a general-purpose computer that is capable of performing various functions by installing various programs, or the like.

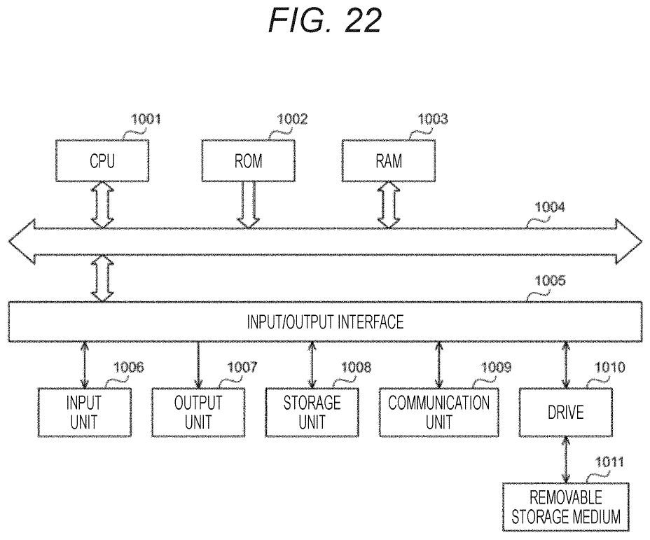

FIG. 22 illustrates a configuration example of a general-purpose computer. This computer includes a central processing unit (CPU) 1001. An input/output interface 1005 is connected to the CPU 1001 via a bus 1004. A read only memory (ROM) 1002 and a random access memory (RAM) 1003 are connected to the bus 1004.

To the input/output interface 1005, an input unit 1006 including an input device such as a keyboard and a mouse by which a user inputs operation commands, an output unit 1007 that outputs a processing operation screen and an image of a processing result to a display device, a storage unit 1008 that includes a hard disk drive and the like and stores programs and various data, and a communication unit 1009 including a local area network (LAN) adapter or the like and performs communication processing via a network represented by the Internet are connected. Furthermore, a drive 1010 that reads and writes data from and to a removable storage medium 1011 such as a magnetic disk (including flexible disk), an optical disc (including compact disc-read only memory (CD-ROM) and digital versatile disc (DVD)), a magneto-optical disk (including mini disc (MD)), or a semiconductor memory is connected.

The CPU 1001 performs various processing in accordance with a program stored in the ROM 1002, or a program read from the removable storage medium 1011 such as a magnetic disk, an optical disc, a magneto-optical disk, or a semiconductor memory, installed in the storage unit 1008, and loaded from the storage unit 1008 into the RAM 1003. Furthermore, the RAM 1003 also appropriately stores data necessary for the CPU 1001 to perform various processing, and the like.

In the computer configured as described above, for example, the CPU 1001 loads the program stored in the storage unit 1008 into the RAM 1003 via the input/output interface 1005 and the bus 1004 and executes the program, to thereby perform the above-described series of processing.

The program executed by the computer (CPU 1001) can be provided by being recorded in the removable storage medium 1011 as a package medium or the like, for example. Furthermore, the program can be provided via a wired or wireless transmission medium, such as a local area network, the Internet, or digital satellite broadcasting.

In the computer, the program can be installed in the storage unit 1008 via the input/output interface 1005 by attaching the removable storage medium 1011 to the drive 1010. Furthermore, the program can be received by the communication unit 1009 via a wired or wireless transmission medium and installed in the storage unit 1008. In addition, the program can be installed in the ROM 1002 or the storage unit 1008 in advance.

Note that the program executed by the computer may be a program that performs processing in a time-series manner in the order described in the present description, or may be a program that performs processing in parallel or at necessary timing such as when a call is made.

Note that the CPU 1001 in FIG. 22 implements the functionality of the automated driving simulator 201 in FIG. 15.

Furthermore, in the present specification, a system is intended to mean assembly of a plurality of components (devices, modules (parts), and the like) and it does not matter whether or not all the components are in the same casing. Therefore, a plurality of devices accommodated in separate housings and connected via a network and one device in which a plurality of modules is accommodated in one housing are both systems.

Note that embodiments of the present disclosure are not limited to the embodiments described above, and various modifications may be made without departing from the scope of the present disclosure.

For example, the present disclosure may have a configuration of cloud computing in which one function is shared by a plurality of devices via a network and processing is performed in cooperation.

Furthermore, each step described in the flowcharts described above may be executed by one device, or can be performed by a plurality of devices in a shared manner.

Moreover, in a case where a plurality of processing is included in one step, the plurality of processing included in one step can be performed by one device or by a plurality of devices in a shared manner.

Note that the present disclosure may have the following configurations.

<1>

An information processing device including:
a storage unit configured to store a radio wave interference model for a radar device mounted on a vehicle in a simulation environment;
a selection unit configured to select the radio wave interference model stored in the storage unit on the basis of a simulation scenario; and
a radar model configured to generate output data representing a result of perception of an object with the radar device on the basis of the radio wave interference model selected by the selection unit.
   <2>

The information processing device according to <1>, in which
the radar model generates a mixed signal for the radar device by mixing a reception wave based on the radio wave interference model and a transmission wave from the radar device, and outputs the mixed signal as the output data representing the result of perception of the object with the radar device.
   <3>

The information processing device according to <2>, in which
the radar device includes a millimeter-wave radar, and
the radar model generates an intermediate frequency (IF) signal for the millimeter-wave radar by mixing a reception wave including a millimeter-wave signal based on the radio wave interference model and a transmission wave including a millimeter-wave signal from the radar device, and outputs the IF signal as output data representing a result of perception of an object with the millimeter-wave radar.
   <4>

The information processing device according to any one of <1> to <3>, further including
a rendering model configured to simulate, as the radio wave interference model, data on a reception wave including an electromagnetic wave propagating from a surrounding space to the radar device in a virtual running environment of the vehicle set on the basis of the simulation scenario.
   <5>

The information processing device according to <4>, in which
the storage unit stores the radio wave interference model simulated by the rendering model in association with the simulation scenario.
   <6>

The information processing device according to <5>, in which
when the radio wave interference model stored in the storage unit can be retrieved on the basis of the simulation scenario, the selection unit selects the radio wave interference model stored in association with the simulation scenario, and
when the radio wave interference model corresponding to the simulation scenario cannot be retrieved, the rendering model simulates, as the radio wave interference model, the reception wave including the electromagnetic wave propagating from the surrounding space to the radar device in the virtual running environment of the vehicle set on the basis of the simulation scenario, and the storage unit stores the radio wave interference model that has been simulated in association with the simulation scenario.
   <7>

The information processing device according to any one of <1> to <6>, in which
the radio wave interference model includes data on a reception wave when, in a virtual running environment of the vehicle set on the basis of the simulation scenario, a reflected wave corresponding to a transmission wave of the radar device reflected off a preceding vehicle to be measured running ahead of the vehicle is received, and a transmission wave from another radar device mounted on another vehicle different from the vehicle and the preceding vehicle, the another radar device being different from the radar device, is received.
   <8>

The information processing device according to <7>, in which
the radio wave interference model includes data on a reception wave when, in the virtual running environment of the vehicle set on the basis of the simulation scenario, the reflected wave corresponding to the transmission wave of the radar device reflected off the preceding vehicle is received, and a transmission wave from the another radar device mounted on an oncoming vehicle with respect to the vehicle is directly received.
   <9>

The information processing device according to <7>, in which
the radio wave interference model includes data on a reception wave when, in the virtual running environment of the vehicle set on the basis of the simulation scenario, the reflected wave corresponding to the transmission wave of the radar device reflected off the preceding vehicle is received, and a transmission wave from the another radar device mounted on an oncoming vehicle with respect to the vehicle is indirectly received.
   <10>

The information processing device according to <9>, in which
the radio wave interference model includes data on a reception wave when, in a case where the virtual running environment of the vehicle set on the basis of the simulation scenario is inside of a tunnel, the reflected wave corresponding to the transmission wave of the radar device reflected off the preceding vehicle is received, the transmission wave from the another radar device mounted on the oncoming vehicle with respect to the vehicle is directly received, and a reflected wave generated when the transmission wave from the another radar device is reflected off a wall of the tunnel is indirectly received.
   <11>

The information processing device according to <7>, in which
the simulation scenario includes information indicating that a modulation method applied to the transmission wave from the radar device is different from a modulation method applied to the transmission wave from the another radar device.
   <12>

The information processing device according to <7>, in which
the simulation scenario includes information indicating that a modulation method applied to the transmission wave from the radar device is the same as a modulation method applied to the transmission wave from the another radar device.
   <13>

The information processing device according to <7>, in which
the simulation scenario includes information indicating that the transmission wave from the radar device is modulated and the transmission wave from the another radar device is not modulated.
   <14>

An information processing method of an information processing device including a storage unit configured to store a radio wave interference model for a radar device mounted on a vehicle in a simulation environment, the information processing method including:
selecting the radio wave interference model stored in the storage unit on the basis of a simulation scenario; and
generating output data representing a result of perception of an object with the radar device on the basis of the radio wave interference model selected.
   <15>

A program causing a computer to function as:
a storage unit configured to store a radio wave interference model for a radar device mounted on a vehicle in a simulation environment;
a selection unit configured to select the radio wave interference model stored in the storage unit on the basis of a simulation scenario; and
a radar model configured to generate output data representing a result of perception of an object with the radar device on the basis of the radio wave interference model selected by the selection unit.

### REFERENCE SIGNS LIST

201 Automated driving simulator
211 Running environment-electromagnetic wave propagation-sensor model
212 Automated driving model
221 Rendering model
222 Perception model
223 Recognition model
231 Imager model
232 Millimeter-wave radar model
233 LiDAR model
251 Scenario selection unit
252 Environment simulator
253 Storage unit
261 Transmission unit
262 Reception unit
263 IF signal generation unit

1. An information processing device comprising:
a storage unit configured to store a radio wave interference model for a radar device mounted on a vehicle in a simulation environment;
a selection unit configured to select the radio wave interference model stored in the storage unit on a basis of a simulation scenario; and
a radar model configured to generate output data representing a result of perception of an object with the radar device on a basis of the radio wave interference model selected by the selection unit.

2. The information processing device according to claim 1, wherein
the radar model generates a mixed signal for the radar device by mixing a reception wave based on the radio wave interference model and a transmission wave from the radar device, and outputs the mixed signal as the output data representing the result of perception of the object with the radar device.

3. The information processing device according to claim 2, wherein
the radar device includes a millimeter-wave radar, and
the radar model generates an intermediate frequency (IF) signal for the millimeter-wave radar by mixing a reception wave including a millimeter-wave signal based on the radio wave interference model and a transmission wave including a millimeter-wave signal from the radar device, and outputs the IF signal as output data representing a result of perception of an object with the millimeter-wave radar.

4. The information processing device according to claim 1, further comprising
a rendering model configured to simulate, as the radio wave interference model, data on a reception wave including an electromagnetic wave propagating from a surrounding space to the radar device in a virtual running environment of the vehicle set on a basis of the simulation scenario.

5. The information processing device according to claim 4, wherein
the storage unit stores the radio wave interference model simulated by the rendering model in association with the simulation scenario.

6. The information processing device according to claim 5, wherein
when the radio wave interference model stored in the storage unit can be retrieved on a basis of the simulation scenario, the selection unit selects the radio wave interference model stored in association with the simulation scenario, and
when the radio wave interference model corresponding to the simulation scenario cannot be retrieved, the rendering model simulates, as the radio wave interference model, the reception wave including the electromagnetic wave propagating from the surrounding space to the radar device in the virtual running environment of the vehicle set on a basis of the simulation scenario, and the storage unit stores the radio wave interference model that has been simulated in association with the simulation scenario.

7. The information processing device according to claim 1, wherein
the radio wave interference model includes data on a reception wave when, in a virtual running environment of the vehicle set on a basis of the simulation scenario, a reflected wave corresponding to a transmission wave of the radar device reflected off a preceding vehicle to be measured running ahead of the vehicle is received, and a transmission wave from another radar device mounted on another vehicle different from the vehicle and the preceding vehicle, the another radar device being different from the radar device, is received.

8. The information processing device according to claim 7, wherein
the radio wave interference model includes data on a reception wave when, in the virtual running environment of the vehicle set on a basis of the simulation scenario, the reflected wave corresponding to the transmission wave of the radar device reflected off the preceding vehicle is received, and a transmission wave from the another radar device mounted on an oncoming vehicle with respect to the vehicle is directly received.

9. The information processing device according to claim 7, wherein
the radio wave interference model includes data on a reception wave when, in the virtual running environment of the vehicle set on a basis of the simulation scenario, the reflected wave corresponding to the transmission wave of the radar device reflected off the preceding vehicle is received, and a transmission wave from the another radar device mounted on an oncoming vehicle with respect to the vehicle is indirectly received.

10. The information processing device according to claim 9, wherein
the radio wave interference model includes data on a reception wave when, in a case where the virtual running environment of the vehicle set on a basis of the simulation scenario is inside of a tunnel, the reflected wave corresponding to the transmission wave of the radar device reflected off the preceding vehicle is received, the transmission wave from the another radar device mounted on the oncoming vehicle with respect to the vehicle is directly received, and a reflected wave generated when the transmission wave from the another radar device is reflected off a wall of the tunnel is indirectly received.

11. The information processing device according to claim 7, wherein
the simulation scenario includes information indicating that a modulation method applied to the transmission wave from the radar device is different from a modulation method applied to the transmission wave from the another radar device.

12. The information processing device according to claim 7, wherein
the simulation scenario includes information indicating that a modulation method applied to the transmission wave from the radar device is the same as a modulation method applied to the transmission wave from the another radar device.

13. The information processing device according to claim 7, wherein
the simulation scenario includes information indicating that the transmission wave from the radar device is modulated and the transmission wave from the another radar device is not modulated.

14. An information processing method of an information processing device including a storage unit configured to store a radio wave interference model for a radar device mounted on a vehicle in a simulation environment, the information processing method comprising:
selecting the radio wave interference model stored in the storage unit on a basis of a simulation scenario; and
generating output data representing a result of perception of an object with the radar device on a basis of the radio wave interference model selected.

15. A program causing a computer to function as:
a storage unit configured to store a radio wave interference model for a radar device mounted on a vehicle in a simulation environment;
a selection unit configured to select the radio wave interference model stored in the storage unit on a basis of a simulation scenario; and
a radar model configured to generate output data representing a result of perception of an object with the radar device on a basis of the radio wave interference model selected by the selection unit.
